(19) United States
(12) Patent Application Publication
(10) Pub. No.: US 2016/0015213 A1
(43) Pub. Date: Jan. 21, 2016

(54) DEEP FRYER WITH AUTOMATIC BATTER FILTRATION

(71) Applicant: RESFAB EQUIPMENT, INC., St-Jean-Sur-Richelieu (CA)

(72) Inventors: Patrick HALLÉ, Sainte-Angele-de-Monnoir (CA); Robert MASSÉ, Saint-Jean-sur-Richelieu (CA); Patrick SIMARD, Saint-Jean-sur-Richelieu (CA)

(21) Appl. No.: 14/336,437

(22) Filed: Jul. 21, 2014

(51) Int. Cl. A47J 37/12; B23K 31/02; B23K 1/00

(52) U.S. Cl. CPC A47J 37/1223; B23K 1/0008; B23K 31/02

(57) ABSTRACT

The deep fryer has a frying basin having four lateral walls and a bottom wall having at least one drain, the four lateral walls being arranged in a rectangular cross-section configuration, and the bottom wall has a funnel shape to entrain oil contained therein to the at least one drain during oil drainage; an oil line leading from a drain to an oil recirculation aperture leading back into the frying basin; a filter and a recirculation pump provided within the oil line in a manner for the pump to be operable to pump the drained oil across the filter and to the recirculation aperture. The action of the pump cooperates with the shape of the bottom wall of the frying basin to clean the bottom wall of the frying basin from batter crumbs and to entrain the batter crumbs to the filter when required.

### BACKGROUND

Large ‘Restaurant’ deep fryers are widely used to bake foods for consumers. Some large-surface restaurants can have a plurality of deep fryers operating simultaneously to allow cooking sufficient food for many consumers.

High-quality frying often warrants filtration of the oil between successive cooking steps. Oil filtration is undertaken to remove animal oils or fat which can become mixed with the vegetable oil when meat is cooked. Removing the animal oils/fat from the vegetable oil can significantly improve taste as the animal oils/fat freed from the meat of one cooked batch can carry the taste of that meat (e.g. chicken) to a subsequent cooked batch (e.g. potatoes), if the animal oil/fat is not removed, thus ‘contaminating’ the following batch of food by leaving some of its taste on it. As a result, if the vegetable oil is not filtered during a plurality of successive fried batches of different types of food, the consumer can have the impression that all the different types of food cooked during the successive batches carry a collective taste—which is associated by consumers to low quality frying techniques.

Another advantage which can result from filtering the oil frequently is that the oil can be used for a greater number of batches.

While one can understand the benefits of oil filtration from reading the above explanation, it is important to note that oil filtration (or replacement) is also associated to a significant cost. For instance, when battered foods are fried with the deep fryer, fried batter tends to free itself from the food during frying and fall to the bottom of the fryer. In such cases, even if the oil is emptied from the fryer, the fried batter crumbs tend to remain on the bottom of the fryer. The fried batter crumbs can contain a significant amount of animal oil/fat and can lead to taste cross-contamination if they are left in the fryer between successive batches of food. It was known to remove such fried batter crumbs manually between batches to provide fried food of a satisfactory quality.

Accordingly, although known fryers and their methods of operation were satisfactory to a certain degree, there remained room for improvement. In particular, it was desired to address the issue of human intervention required to remove the fried batter crumbs, especially when battered animal foods are fried between successive batches of other foods.

### SUMMARY

A deep fryer having an automatic filtration system is described, wherein a directed oil recirculation jet can cooperate with a shape of the bottom of the frying basin to entrain batter crumbs into the drain and into the filter.

In accordance with one aspect, there is provided a deep fryer comprising: a frying basin having four lateral walls and a bottom wall having at least one drain, wherein the four lateral walls are arranged in a rectangular cross-section configuration and the bottom wall has a funnel shape to entrain oil contained therein to the at least one drain during oil drainage; an oil line leading from at least one drain to at least one oil recirculation aperture leading back into the frying basin; a filter and a recirculation pump provided within the oil line in a manner for the pump to be operable to pump the drained oil across the filter and to the at least one oil recirculation aperture; wherein the action of the recirculation pump cooperates with the shape of the bottom wall of the frying basin to clean the bottom wall of the frying basin from batter crumbs and to entrain the batter crumbs to the filter when required.

Many further features and combinations thereof concerning the present improvements will appear to those skilled in the art following a reading of the instant disclosure.

### BRIEF DESCRIPTION OF THE FIGURES

In the figures:

FIG. 1 is an oblique view of an example of a deep fryer;

FIG. 2A is an oblique view of a first example embodiment of a bottom wall for a deep fryer, with FIG. 2B being a cross-section view thereof;

FIG. 3A is an oblique view of a second example embodiment of a bottom wall for a deep fryer, with FIG. 3B being a cross-section view thereof; and

FIG. 4 is an oblique view of the deep fryer of FIG. 1, showing additional detail.

### DETAILED DESCRIPTION

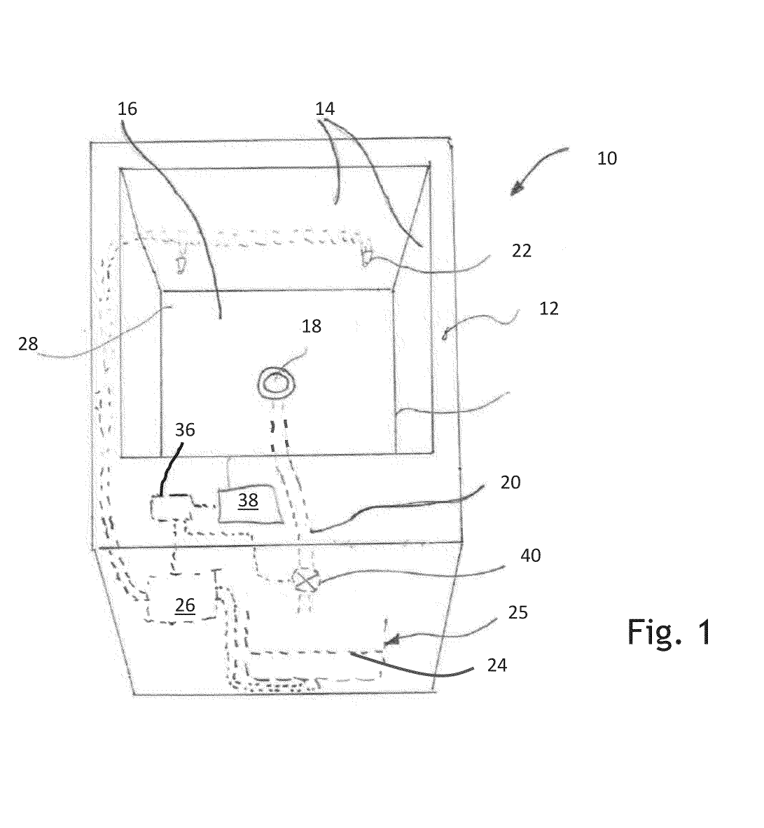

FIG. 1 shows an example of a deep fryer 10 generally comprising a frying basin 12 having four lateral walls 14 extending downwardly to a bottom wall 16 which forms the bottom of the frying basin 12. A drain 18 is provided in the bottom wall 16 to drain the oil. As shown schematically, an oil line 20 extends from the drain 18 to one or more recirculation apertures 22 provided here in the lateral walls 14 of the frying basin 12. A filter 24 and a recirculation pump 26 are provided, in sequence, in the oil line 20, to successively filter and recirculate the oil back to the frying basin 12. Heating elements are not shown for simplicity. In this embodiment, a single drain 18 is provided, though it will be understood that in alternate embodiments, a plurality of drains can be provided as found suitable by the designer.

When frying battered foods with the deep fryer 10, some batter can tend to fall on the bottom wall 16 and accumulate thereon. Draining the oil with the drain causes, firstly, local acceleration of the oil adjacent the drain accelerating it to a relatively high speed in the drain, and, as oil exits the frying basin 12 through the drain 18, the volume of oil progressively lowers at a collective, relatively low speed. The gradient of speed of the oil during the drainage operation varies as a function of time, but it is correct to state that the speed of the oil adjacent the drain 18 is typically greater than the speed of the oil at other regions of the frying basin 12. Generally, throughout the drainage operation, the speed of the oil can be said to be progressively lower at locations farther and farther from the drain 18. According to this fluid mechanics effect, the speed of the oil adjacent the drain 18 will generally be sufficient to entrain the batter lying there into the drain and into the filter 24. However, at locations farther away from the drain 18, as the speed of the oil during drainage decreases, the speed of the oil was not sufficient to entrain the batter.

In cases of deep fryers having rectangular cross-sections such as the one illustrated in FIG. 1, the speed of the oil near the corners 28 can be particularly low, and such corners can thus form areas where batter crumbs can accumulate and tend to remain during drainage.

In this embodiment, these accumulations of batter crumbs can be addressed by one or more potentially redundant aspects.

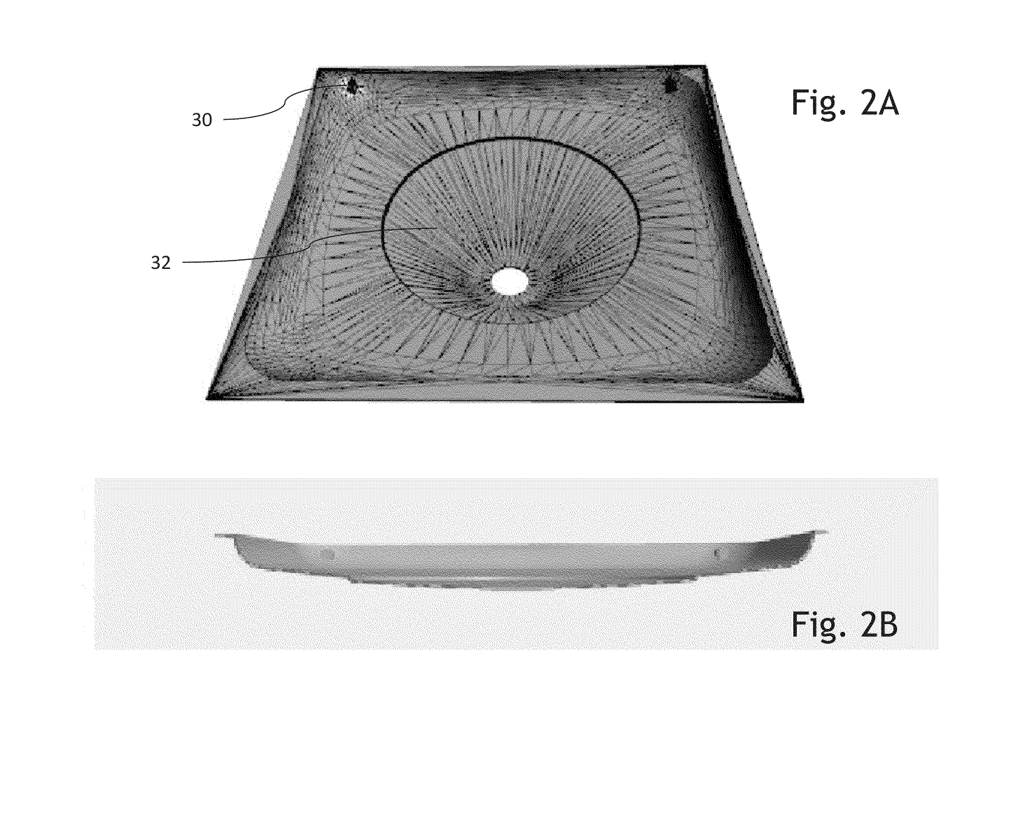

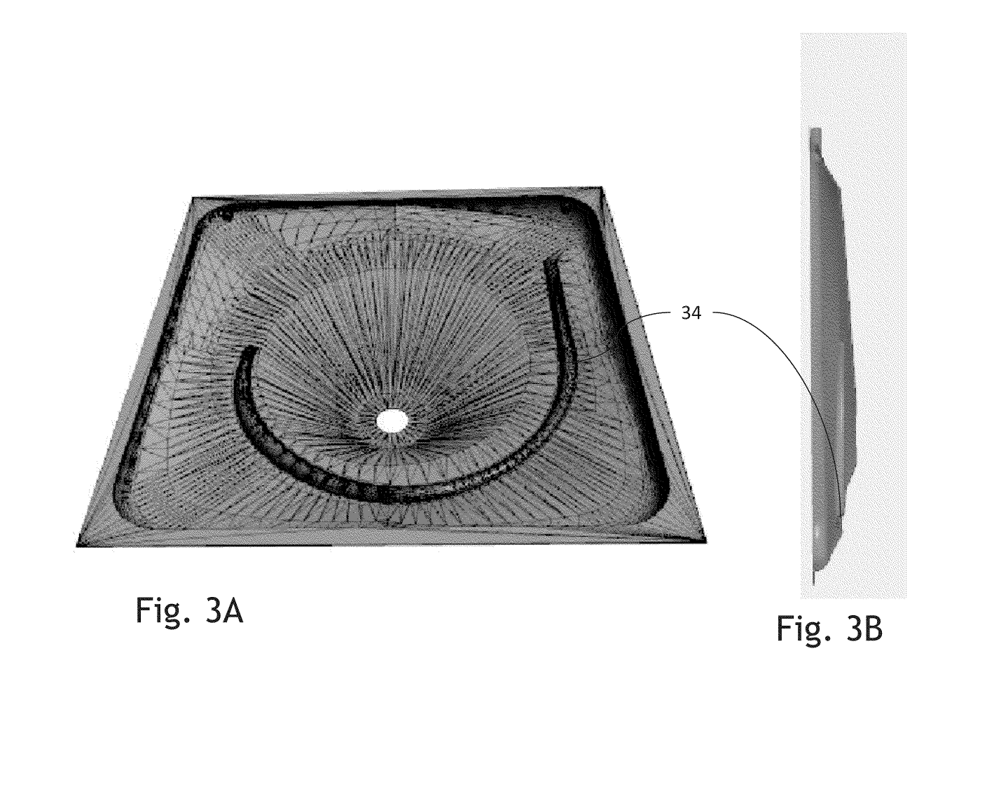

A first aspect to address such resilient batter crumb accumulations is to provide the bottom wall 16 of the frying basin 12 with a funnel shape. Examples of bottom walls with funnel shapes are shown in FIGS. 2A, 2B, 3A, and 3B. The funnel shape tends to enlarge the area of sufficiently high oil speed along the bottom wall as compared to a flat bottom wall, and can thus allow a better cleaning of the batter crumbs which would otherwise remain on the bottom wall, a little farther away from the drain. A relatively slight funnel shape, such as shown in the figures, can be sufficient to achieve the objectives, and can also be preferred as opposed to a more pronounced funnel shape for production or operation considerations. In particular, it can allow the bottom wall to be formed from a single sheet of sheet metal, for instance, which will be discussed further below. Many alternate funnel shapes, generally having an elevation of the outer edges/corners which is higher than the elevation of the drain can be used in alternate embodiments. In the illustrated embodiments, the elevation of the outer edges/corners slopes relatively progressively toward the lower elevation of the drain, which was found suitable in these embodiments.

A second aspect to address the issue of resilient batter crumb accumulations is to provide the corners of the bottom wall, and/or the junction between the bottom wall and the lateral walls, with a smooth, ‘aerodynamic’ curve, to allow the oil to flow more freely along that area and preserve the fluid speed which is used to clear the batter crumb accumulations. FIGS. 2A, 2B, 3A, 3B show examples of bottom walls which have a smooth, aerodynamic curve at all four corners. The smooth aerodynamic curve can be characterized by a combination of a horizontal curve and a vertical curve. In embodiments where the production cost considerations allow it, the four junctions between the four lateral walls can be made curved as well in a manner to form a smooth continuation when they meet the horizontally-rounded corners of the bottom wall.

A third aspect to address the issue of resilient batter crumb accumulations is to use the velocity of the recirculated oil, which typically involves providing one or more oil recirculation aperture(s) with nozzle(s) 30 to form jet(s) of oil returning into the frying basin once filtered (in FIG. 2A, the nozzles 30 are provided in the rounded edges of the bottom wall rather than in the lateral walls). This can be done in two independent ways. A first way is to position and orient at least one jet of oil in a manner to contribute to the formation of a vortex inside the frying basin to generate a tangential velocity to the oil which adds to the radial velocity which can be imparted by gravity or pumping (such as by aligning the nozzle 30 with an edge of the bottom for instance). Another way to is to position and orient jets of oil in a manner to specifically target the areas of resilient batter crumb accumulations by imparting a satisfactorily high oil velocity at those locations. This can be done by aiming jets of oil to the four corners of the frying basin, for instance. The jets of oil aiming areas of potential resilient batter crumb accumulations can either operate simultaneously, or sequentially. Sequential operation can be achieved by the use of valves controlled by a controller, for instance.

A fourth aspect to address the issue of resilient batter crumb accumulations is to provide the funnel shape of the bottom wall with geometrical features specifically designed for this reason. Both FIGS. 2A and 3A show a bottom wall having a curved closed-loop shape depression 32 formed therein, surrounding the drain. This curved closed-loop shape is circular in this specific embodiment, but can vary in others. Moreover, the embodiment shown in FIGS. 3A and 3B is provided with a curved rib 34 formed in the bottom wall and configured to contribute to the formation of a vortex.

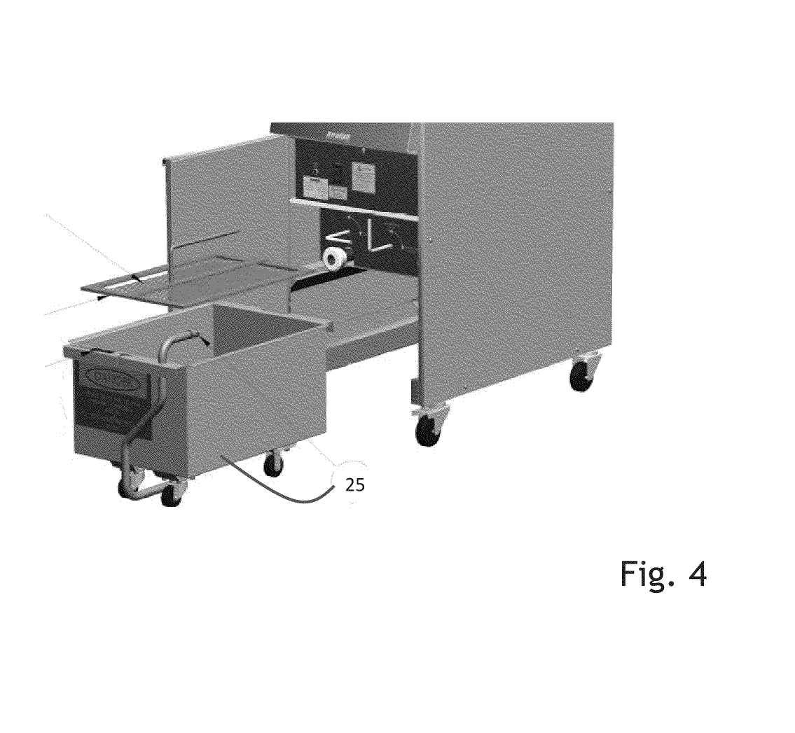

In the embodiment shown in FIG. 1, the pump 26 is controlled automatically by a controller 36, a user interface 38 is provided, and the filter 24 is provided inside an auxiliary oil tank 25, which can be provided with an open-top and wheels so as to be freely removable from the deep fryer for discharging the used oil, for instance (see FIG. 4). The filter can be a weaved or felted fabric, or a permanent metal filter for instance, with the oil line being connected to a bottom part of the tank to allow the pump to drain the used oil after it has permeated through the filter, for instance. The pump 26 can be controlled to clean batter crumbs automatically after each fried batch, or can be activated manually, via the user interface, when requested by a user, to name two examples. In this embodiment, the controller 36 directs a filtration cycle by first activating a valve 40 to drain the oil into the auxiliary tank 25. The valve 40 can be a motor-controlled valve or a solenoid valve in such a case, for instance. The controller 36 can then take a pause of a given amount of time to allow the oil to settle, before activating the pump 26 to pump the oil across the filter 24. The controller can be provided with a program which has the data about the process parameters and which can further include a specific sequence of independently activating respective ones of the recirculation apertures 22, for instance, or repeating the cycle a given number of times. In an alternate embodiment, the valve 40 can be a manual valve and the pump can be controlled manually rather than via a controller.

The deep fryer shown in FIG. 1 can be produced by forming the bottom wall 16 from a single sheet of metal. The bottom wall preform can be cut from a flat sheet of sheet metal, and the funnel shape can be formed by any suitable sheet forming process, such as hydro forming or press-forming, for instance. In this embodiment, the bottom wall is then soldered to the four lateral walls to form the frying basin of the deep fryer.

As can be understood, the examples described above and illustrated are intended to be exemplary only. In particular, the expression ‘rectangular cross-section’ is specifically intended to include a square cross-section, as well as rectangular cross-sections having rounded corners. The scope is indicated by the appended claims.

What is claimed is:

1. A deep fryer comprising:
a frying basin having four lateral walls and a bottom wall having at least one drain, wherein the four lateral walls are arranged in a rectangular cross-section configuration and the bottom wall has a funnel shape to entrain oil contained therein to the at least one drain during oil drainage;
an oil line leading from at least one drain to at least one oil recirculation aperture leading back into the frying basin;
a filter and a recirculation pump provided within the oil line in a manner for the pump to be operable to pump the drained oil across the filter and to the at least one oil recirculation aperture;
wherein the action of the recirculation pump cooperates with the shape of the bottom wall of the frying basin to clean the bottom wall of the frying basin from batter crumbs and to entrain the batter crumbs to the filter when required.

2. The deep fryer of claim 1, wherein the at least one oil recirculation aperture is provide in the form of at least one corresponding nozzle configured for producing an oil jet during the recirculation pumping of the oil.

3. The deep fryer of claim 2, wherein said at least one nozzle is positioned and oriented in a manner to cooperate with the shape of the frying basin to generate a higher velocity of oil movement in at least one area where batter crumbs could otherwise tend to remain during drainage.

4. The deep fryer of claim 3, wherein at least one said area where batter crumbs would otherwise tend to remain is a corner of the frying basin.

5. The deep fryer of claim 3, wherein the bottom wall is formed with at least one fluid movement guide configured to cooperate with the at least one nozzle and guide oil movement to the at least one area where batter crumbs could otherwise tend to remain.

6. The deep fryer of claim 2, wherein said at least one nozzle is positioned and oriented in a manner to contribute to the formation of a vortex during said oil recirculation pumping.

7. The deep fryer of claim 1, wherein four corners of the rectangular bottom wall are curved both horizontally and vertically in a manner to favor fluid flow thereacross.

8. The deep fryer of claim 7, wherein the four lateral walls are joined to one another via a curved inner radius corresponding to the horizontal curve of the rectangular bottom wall and form a smooth transition therewith.

9. The deep fryer of claim 1, wherein the bottom wall has a closed-loop shape depression formed therein, with said drain provided within the closed-loop shape depression.

10. The deep fryer of claim 9 wherein the closed-loop shape is circular and the drain is provided centrally relative to the closed-loop shape.

11. The deep fryer of claim 1, wherein the funnel shape of the bottom wall is further configured to favor the formation of a vortex during drainage.

12. The deep fryer of claim 2, wherein there are at least two of said nozzles, and the deep fryer further comprises a valve and an associated controller to subsequently direct a flow of oil to a first one of said two nozzles and then to a second one of said two nozzles.

13. The deep fryer of claim 2, wherein there are at least two of said nozzles, each one of said nozzles being directed to a corresponding one of the corners.

14. The deep fryer of claim 1, wherein the bottom wall is soldered to the four lateral walls.

15. A method of operating a deep fryer as claimed in claim 12, the method comprising sequentially operating the at least two nozzles.

16. A method of making a deep fryer as claimed in claim 1, the method comprising forming the bottom wall with the funnel shape and soldering the bottom wall to the four lateral walls.
